(19) United States
(12) Patent Application Publication
(10) Pub. No.: US 2018/0066767 A1
(43) Pub. Date: Mar. 8, 2018

(54) FRAC VALVE OPEN/CLOSED INDICATOR

(71) Applicant: Dustin Wayne Nesloney, Orange Grove, TX (US)

(72) Inventor: Dustin Wayne Nesloney, Orange Grove, TX (US)

(21) Appl. No.: 15/359,835

(22) Filed: Nov. 23, 2016

Related U.S. Application Data
(60) Provisional application No. 62/495,256, filed on Sep. 6, 2016.

(51) Int. Cl. F16K 37/00; F16K 3/02

(52) U.S. Cl. CPC F16K 37/0008; F16K 3/02

(57) ABSTRACT

An open/closed indicator is positioned on the balance stem end of a high pressure gate valve and operates mechanically to expose symbols which are universally understood to state whether the valve is open or closed. The indicator is two sided and the open/closed symbols are exposed on opposite sides of the valve. In one embodiment, an indicator panel is connected directly to the balance stem of the valve. In other embodiment, an indicator panel is biased by a spring against the balance stem. In another embodiment, the indicator panel is pivoted to an extension of the balance stem. In all embodiments, the indicator panel is operatively connected to the balance stem and mimics movement of the balance stem and thus the valve gate.

This application is partially based on Provisional Application Ser. No. 62/495/256, filed Sep. 6, 2016, priority of which is claimed.

This invention relates to an indicator for a frac valve or other similar valve to show whether the valve is open or closed.

### BACKGROUND OF THE INVENTION

In many situations, it is desirable to know whether a valve is open or closed without incurring a great deal of time, effort or expense. One such situation is in tracing hydrocarbon wells. It often occurs that a fracing operation commences when one valve in a stack of valves controlling flow into the well is closed rather than open. What happens is that the pump truck delivers a high pressure slurry of proppant, water and chemicals toward the well when one of the valves is closed. Nothing moves, of course, and the operation must stop and start over after the valve is opened.

When a large frac job is done, there may be a large number of pumping cycles including many stops and starts. There is an inherent danger that repeated pumping against a closed valve may eventually produce enough wear and tear on a line or component of the system to rupture it thereby delivering a high pressure stream of proppant, water and chemicals in an area full of equipment and people. At the least, repeated overpressuring a valve, piping and other equipment leads to early maintenance requirements or premature equipment failure.

In a fracing operation, one can test equipment before the operation begins but, because of numerous pumping cycles in the operation, it is basically impractical to stop the operation and retest equipment. One has to rely on the integrity of the equipment, for example, during a hundred or more pumping cycles.

Disclosures of interest are found in U.S. Pat. Nos. 3,238,915; 3,452,766; 4,406,303; 4,448,148; 4,494,566; 4,497,340; 5,178,187; 5,320,325; 6,601,650; 6,820,647; 9,091,351; 9,188,241 and U.S. Printed Patent Applications 20020124883 and 20120001101.

### SUMMARY OF THE INVENTION

In this invention, an indicator housing is attached to a horizontal gate valve and an indicator is mounted inside the housing. In one embodiment, an extension is attached to a balance stem of a horizontal gate valve and to the indicator so that movement of the balance stem exposes either the word “open” or “closed” or a suitable symbol or color that is readily understood by anyone, however inexperienced or how far away. When the valve gate is moved to an open position, the balance stem waves the indicator to expose the word “open” or suitable symbol.

In another embodiment, the indicator is biased by a suitable spring to expose the word “open” or a suitable symbol through an opening in the indicator housing. When the valve gate is moved to the closed position, the balance stem pushes the indicator and partially collapses the spring to expose the word “closed” or suitable symbol through the housing opening. When the valve moves to the open position, the spring pushes the indicator against the balance stem to expose the word “open” or other suitable symbol.

The indicator is of sufficient size and shape that it is visible from a substantial distance so anyone within eyesight of the Christmas tree or other wellhead fixture can easily see and understand the condition of the valve. From a close distance, knowledgeable people can look at a conventional horizontal gate valve and tell whether the valve is open or closed. There are times when the decision of whether the valve is open or closed is made by inexperienced personnel personnel at a distance or personnel under considerable stress thereby making sound decisions questionable.

### BRIEF DESCRIPTION OF THE DRAWINGS

FIG. 1 is a side view of a conventional frac valve shown in an open position and having an indicator secured to the valve housing showing the valve is open, certain parts of an indicator housing being broken away for clarity of illustration;

FIG. 2 is a side view of the valve of FIG. 1 showing the valve and indicator when the valve is closed, certain parts of the indicator housing being broken away for clarity of illustration;

FIG. 3 is a top view of a conventional frac valve having an indicator housing secured to the valve housing;

FIGS. 4 and 5 are front view of indicator panels showing different symbols used to designate open and closed;

FIG. 6 is a side view of part of a conventional frac valve and another embodiment of an open/closed indicator showing whether the valve is open or closed; and

FIG. 7 is a side view of part of a conventional frac valve and another embodiment of an open/closed indicator showing the valve is open, certain parts being broken away for clarity of illustration.

### DETAILED DESCRIPTION OF THE INVENTION

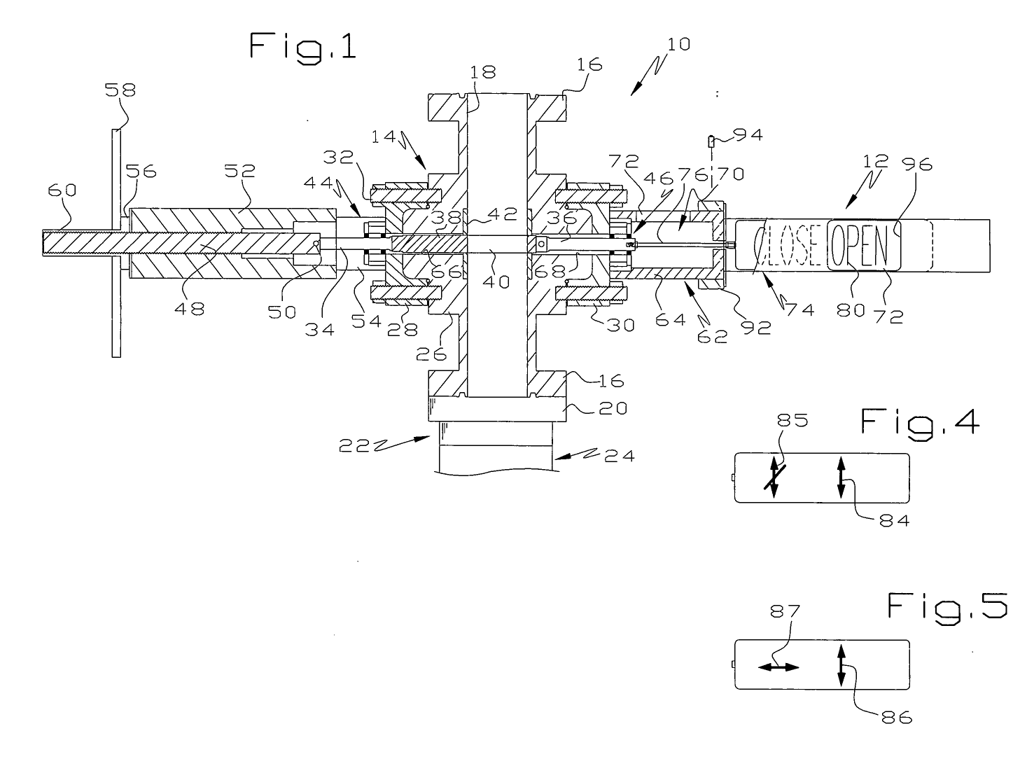

Referring to FIGS. 1-5, a frac valve 10 of conventional construction is equipped with an indicator 12 designating whether the valve 10 is open or closed. The frac valve 10 may be of any suitable type but is illustrated as a horizontal gate valve having a housing or body 14 providing upstream and downstream connections 16 such as flanges and a flow passage 18 between the flanges 16. The lower flange 16 is typically connected to a flange of a master valve (not shown) or a flange 20 of a well head or bradenhead 22 of a well 24 being fraced. One or more similar frac valves may be positioned on top of the valve 10 to provide a frac stack or multiple closures for the frac slurry. The valve housing or body 14 may include a central body section 26 to which are attached bonnets 28, 30 by suitable threaded fasteners 32.

The valve 10 includes an operating or valve stem 34 and a coaxial balance stem 36 connected to a valve gate 38 in the form of a slab or plate of metal having an opening 40 adjacent one end. Seal assemblies 42 act on the valve gate 38 and prevent leakage of liquids or slurries pumped through the valve 10. Suitable seal assemblies 44, 46 seal between the bonnets 28, 30 and the periphery of the operating or valve stem 34 and the balance stem 36.

The valve 10 may be actuated in any suitable manner, as by a hydraulic or pneumatic cylinder a manually operated valve wheel or in any other practical manner. As illustrated, a threaded actuator stem or ball screw 48 connects to the valve stem 34 through a connection 50 allowing some limited movement between the valve stem 34 and the hall screw 48. A long barrel/bearing housing 52 encloses the ball screw 48. The bearing housing 52 connects to the valve bonnet 28 by one or more struts 54 providing a gap exposing the valve stem 34 to earth's atmospheric air. An actuator nut 56 receives the threads of the actuator stem 48 so that rotation of a valve wheel 58 pushes on the actuator stem 48 and moves the actuator stem 48 to the right in FIG. 1 thereby moving the valve gate 38 toward a closed position shown in FIG. 2. The actuator nut 56 may include a compartment 60 which the actuator stem 48 moves into and out of during opening and closing of the valve 10.

In a conventional low pressure gate valve 10, the valve stem 34 extends out of the valve housing 14 and is exposed to atmospheric pressure of earth's air. Pressure inside the valve housing 14 typically is exerted on both ends of the valve gate 38. Because the valve stem 34 extends out of the housing 14, there is less area exposed to high pressure in the valve housing 14 on the end of the valve gate 38 to which the valve stem 34 is attached. The force acting on the valve gate 38 in the valve opening direction is the pressure in the housing 14 multiplied by the difference in the areas of the valve gate 38 exposed to the pressure. This produces a force acting on the valve gate 38 in the valve opening direction. With conventional low pressure gate valves, this force is not material.

However, in high pressure gate valves, the force is considerable and must foe overcome by manual or hydraulic effort applied to the valve stem 34 in the process of moving the valve gate 38 to the open position. Thus, high pressure gate valves 10 are often equipped with a balance stem 36. To balance the force on the valve stem 34, the balance stem 36 must be the same, or nearly the same, outer diameter as the valve stem 34.

If the balance stem 36 is slightly smaller or slightly larger than the valve stem 34, this will create a small net force acting in one direction or the other on the valve gate 38 at times during operation of the valve 10. All manufacturers of high pressure gate valves provide balance stems which are the same area as the valve or operating stem for the simple reason that it is an optimum design. In this invention, the balance stem 36 may be in the range of 95-105% of the area of the operating stem 48 and may preferably be of the same cross-sectional area.

The valve 10 may also include a barrel 62 exposing the end of the balance stem 36 to atmospheric pressure of earth's air. The barrel 62 may include slots 64 for this purpose. Those skilled in the art will acknowledge that the position of the valve gate 33 can be determined by the position of the balance stem 36. For example, viewing through the slots 64, the balance stem 36 retracted as in FIG. 1, meaning the valve 10 is open, or viewed through the slots 64 in FIG. 2, the balance stem 36 is extended, meaning the valve 10 is closed. Unfortunately, this determination can be made only by someone standing on or near the top of the barrel 62 and, in any event, is beyond the ability of inexperienced people and is easy to misjudge, particularly in the stress of the moment, as when an emergency is underway or at night when visibility is poor even if an working area around a well being traced is lit.

Rather than describe the valve 10 in minute detail, the valve 10 may be a conventional horizontal gate valve such as is shown in U.S. Pat. Nos. 4,340,204 or 4,363,465, the disclosures of which is incorporated herein by reference.

Comparing the open and closed positions of FIGS. 1 and 2 respectively shows that movement of the operating stem 48 to the right in FIG. 1 causes the valve stem 34 and valve gate 38 to move to the right and close. This moves the blank part of the valve gate 38 out of the cavity 66 into the flow passage 18 and moves the opening 40 in the valve gate 38 to the right into a cavity 68.

The indicator 12 includes, as major components, an extension 70 attached to the balance stem 36, an indicator member 72 secured to the extension 70 in the embodiment of FIGS. 1-2 and an indicator housing 74 attached to the barrel 62.

The extension 70 and its attachment to the balance stem 36 may be of any suitable type. The extension 70 may be a linkage such as a simple rod 76 threaded at one end to the end of the balance stem 36 and threaded at the other end to a clevis 73 attached to the indicator member 72. The indicator member 72 is operatively connected to the balance stem 36 and according moves linearly in response to movement of the balance stern 36 and thus moves in response to movement of the valve gate 38.

The indicator member 72 may foe of any suitable thickness or shape and may preferably be a planar panel including an open symbol 80 and a closed symbol 83, meaning that the symbols 80, 82 are universally known to mean “open” and “closed.” The symbols 80, 82 may be the words “open” and “closed” as shown in FIGS. 1-2, may be other words universally known to mean “open” and “closed” such as go and no go, flow and no flow, go and stop and the like, and may be colors like red for open and green for closed or may be arrows 84, 85, 86, 87 as shown in FIGS. 4-5. The symbols 80-87 may be sufficiently large and distinct as to be immediately recognizable from a substantial distance, such as 100′. The symbols 80-87 may be exposed on both sides of the indicator housing 74 as more fully pointed out hereinafter. It will be seen that the extension 70 and indicator panel 72 are coaxial with the balance stem 36.

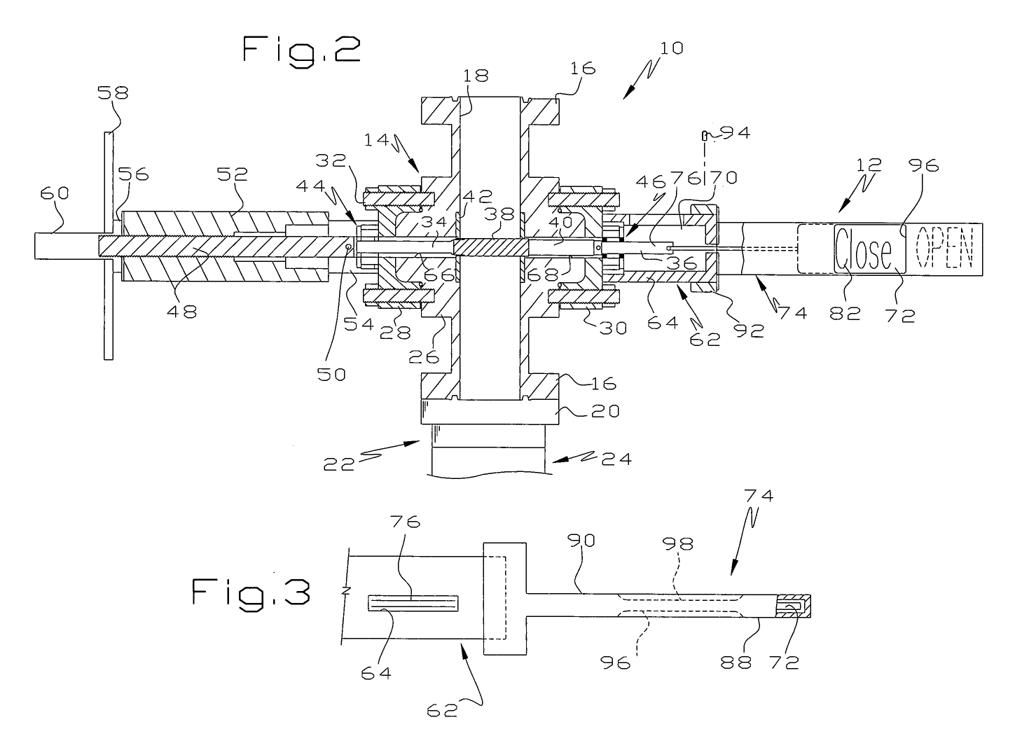

The indicator housing 74 may be roughly rectangular in shape having parallel side walls 88, 90 providing a channel therebetween and suitable end and/or top walls. The indicator panel 72 may be guided by slides or the like inside the housing 74 to assure smooth movement in the channel. The housing 74 may be attached to the valve 10 in any suitable manner, such as by applying a cap 92 to here to the end of the barrel 62 and securing the cap 92 in place with suitable fasteners 94 such as set screws or the like. The indicator housing 74 may be sized to closely receive the indicator panel 72 and may accordingly be relative thin as suggested in FIG. 3. The indicator housing 74 includes an opening 96 on one side facing in one direction perpendicular to the movement of the valve gate 38 and an opening 98 on an opposite side of the housing 74 facing in an opposite direction. Accordingly, the indicator 12 is visible from either side of the valve 10.

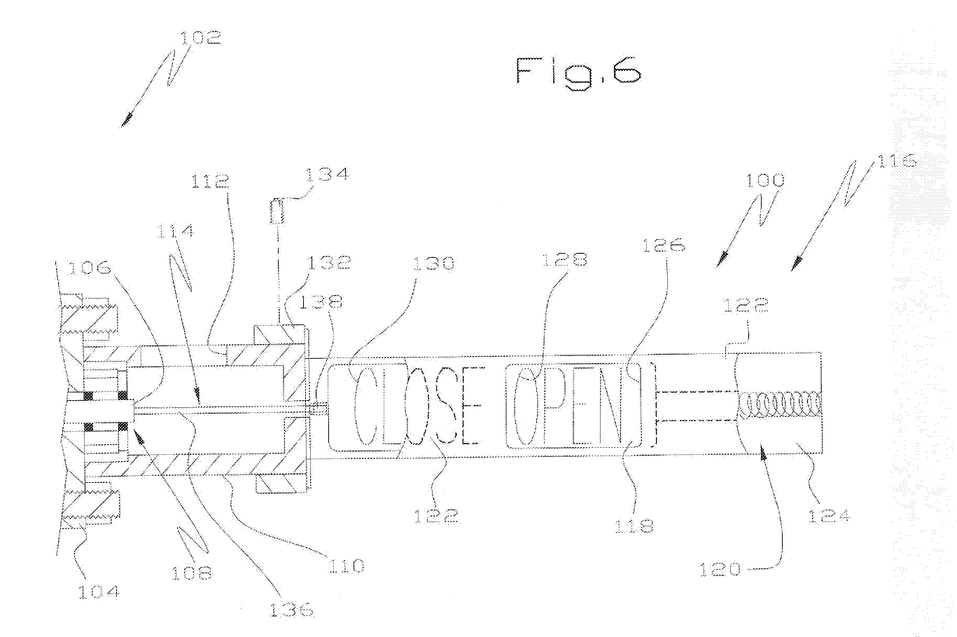

Referring to FIG. 6, another embodiment of an indicator 100 is illustrated on a high pressure gate valve 102 having a bonnet 104 and a balance stem 106 extending through a seal assembly 108 and exposed to earth's atmospheric pressure through a barrel 110 having one or more slots 112 open to the atmosphere. The valve 102 may accordingly be the same valve as is illustrated in FIGS. 1-3.

The indicator 100 includes, as major components, an extension 114 of the balance stem 106, an indicator housing 116, an indicator member 118 and a spring or other biasing means 130 forcing the indicator member 118 to the left in FIG. 6. The housing 116 may be essentially the same as the housing 74 and include side walls 122, 124 each providing an opening 126 exposing one of the symbols 128, 130 indicating whether the valve 102 is open or closed. The housing 114 may be connected to the valve 102 as by slipping a cap 132 over an end of the barrel 110 and securing it in place with one or more suitable fasteners 134.

The balance stem extension 114 may be a rod 136 threaded into the end of the balance stem 106 and includes an opposite end 138 that abuts but does not connect to the indicator member 118. The balance stem extension 114 accordingly pushes the indicator member 118 against the spring 120 during closing movement of the valve 102 to expose the closed symbol 130 through the openings 126. During opening movement of the valve 102, the balance stem 106 retreats to the left in FIG. 6 so the spring 120 pushes the indicator panel 118 to the left against the extension end 138 thereby exposing the open symbol 128. The balance stem 106 is thus operatively connected to the indicator member 118 by the spring 120.

The spring 120 may be of any suitable type such as a long stroke mechanical spring, a gas spring (not shown) or other practical force applier that has a stroke sufficient to move the indicator member 118 from the closed position to the open position.

It will be apparent that other configurations to move the indicator panels 72, 118 are contemplated. In one sense, what is really important is knowing when the frac valve 10 is open so that pumping can begin safely, i.e. so pumped slurry will enter the well 24 rather than pumping against a closed valve where the risk exists of failure of pumps, piping, connections or other equipment.

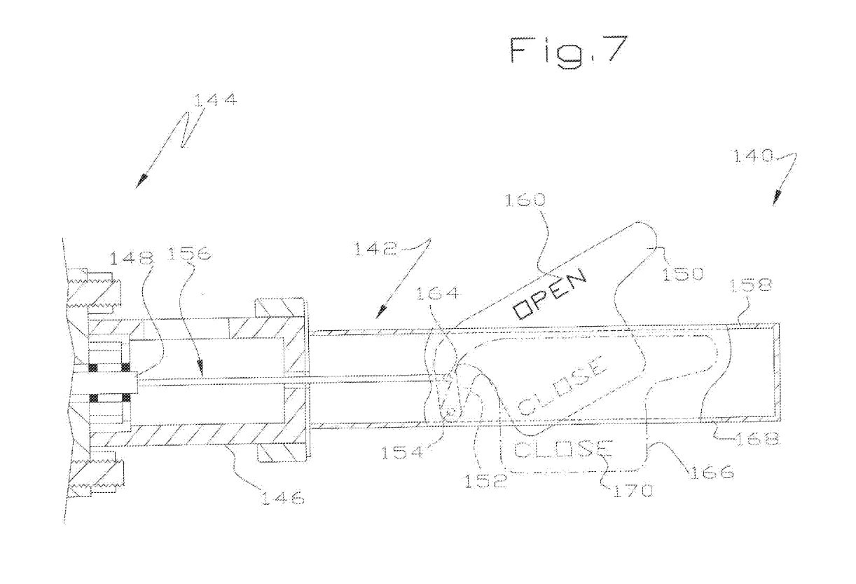

Referring to FIG. 7, an indicator 140 may include an indicator housing 142 fixed to a valve 144 and may be attached to a barrel 146 enclosing a balance stem 148 as in the embodiments of FIGS. 1-6. An indicator panel 150 may include a crank arm 152 pivoted by a pin 154 to the housing 142. A balance stem extension 156 is operatively connected between the balance stem 148 and the panel 150 so that opening movement of a valve gate (not shown) in the valve 144 retracts the extension 156 as shown in FIG. 7. This raises the panel 150 through a slot 158 in a top of the housing 142 thereby exposing a symbol 160 on one or both sides of the panel 150 and indicating that the valve 144 is open. In one sense, the minimum required of the indicator 140 is to indicate one position of the valve 144 which may be the open position. When the valve gate (not shown) of the valve 144 moves to its closed position, the balance stem 148 advances to the right in FIG. 7 thereby allowing gravity to lower the panel 150 through the slot 158 thereby obscuring the symbol 160.

The extension 156 may be sufficiently flexible to accommodate some vertical movement of an end 162 which is pivoted to the panel 150 by a pin 164. To this end, the extension 156 may be a somewhat flexible rod, a length of chain, cable, wire, cord, strap or the like. Some vertical movement of the pin 164 is caused by pivotal movement of the panel 150 around the pin 154. Those skilled in the art will recognize the panel 150 as being a crank.

The indicator panel 150 may also includes a segment 166 extending through a slot 163 in the bottom of the housing 142 as shown in FIG. 7. The segment 166 may include a symbol 170 indicating the valve 144 is closed. When the valve 144 is moved from the closed position to the open position, the balance stem 148 retracts to the left in FIG. 7 thereby retracting the extension 156 and raising the indicator panel 150 to expose the open symbol 160 and hide the closed symbol 170 inside the housing 142. Similarly, when the valve 144 moves from the open position to the closed position, the balance stem 148 advances to the right in FIG. 7 thereby allowing gravity to depress the panel 150 and pass the segment 166 through the slot 168. This exposes the symbol 170 below the housing 142 and simultaneously obscures the symbol 160 inside the housing 142.

FIG. 7 shows the open position of the indicator member 150 in solid lines above the housing 142 and in dashed lines inside the housing 142. FIG. 7 also shows the closed position of the indicator member 150 in dotted lines.

The dimensions of the indicator panel 150 are selected so that, in the open position of the valve 144, the symbol 160 is exposed above the top of the housing 142 and the symbol 170 is obscured inside the housing 142. Similarly, the dimensions of the indicator panel 150 are selected so that, in the closed position of the valve 144, the symbol 160 is obscured inside the housing 142 and the symbol 170 is exposed below the bottom of the housing 142.

Although this invention has been disclosed and described in its preferred forms with a certain degree of particularity, it is understood that the present disclosure of the preferred forms is only by way of example and that numerous changes in the details of operation and in the combination and arrangement of parts may be resorted to without departing from the spirit and scope of the invention as hereinafter claimed.

I CLAIM:

1. A horizontal gate valve comprising a housing providing first and second connections for coupling to adjacent conduits and providing a passage between the connections,
a valve gate comprising
a slab of material having an opening therein, the slab being mounted in the housing for horizontal movement between a position blocking the passage and a position aligning the opening with the passage,
an operating stem on an end of the slab extending through the housing and having an end exposed to earth's atmospheric air exterior of the valve housing, the operating stem having a cross-sectional area, and
a balance stem on an end of the slab opposite from the operating stem, the balance having an end exposed to atmospheric air exterior of the valve housing, the balance stem having a cross-sectional area in the range of 95-105% of the operating stem cross-sectional area, and
an indicator comprising a housing, rigid with the valve housing, providing an opening on first and second sides of the indicator housing and having therein an Indicator member having first and second sides, each side providing symbols indicating open and closed positions of the valve gate, the indicator member and balance stem being configured to position the open symbol in alignment with the housing openings when the operating stem has the valve gate in a position allowing flow through the passage, the indicator member and balance stem being operatively connected and configured to position the closed symbol in alignment with the housing openings when the operating stem has the valve gate in a position blocking flow through the passage.

2. The gate valve of claim 1 wherein the balance stem and the operating stem have equal cross-sectional areas.

3. The gate valve of claim 1 wherein the symbols comprise words.

4. The gate valve of claim 1 wherein the symbols comprise arrows.

5. The gate valve of claim 1 wherein the symbols comprise colors.

6. The gate valve of claim 1 wherein the balance stem is rigid the indicator member.

7. The gate valve of claim 6 further comprising an extension attached to the balance stem and attached to the indicator member.

8. The gate valve of claim 1 wherein the balance stem abuts but is unconnected to the indicator member and further comprising a spring biasing the indicator member against the balance stem.

9. A horizontal gate valve comprising a housing providing first and second connections for coupling to adjacent conduits and providing a passage between the connections,
a valve gate comprising
a slab of material having an opening therein, the slab being mounted in the housing for horizontal movement between a position blocking the passage and a position aligning the opening with the passage,
an operating stem on an end of the slab extending through the housing and having an end exposed to earth's atmospheric air exterior of the valve housing, the operating stem having a cross-sectional area, and
a balance stem on an end of the slab opposite from the operating stem, the balance stem having an end exposed to atmospheric air exterior of the valve housing, the balance stem having a cross-sectional area in the range of 95-105% of the operating stem cross-sectional area, and
a valve open/closed indicator comprising an indicator member exterior of the valve, the indicator member being movable from a first position displaying a first visible symbol indicating an open position of the valve gate to a second position displaying a second different visible symbol indicating a closed position of the valve gate, the first visible symbol being obscured in the closed position of the valve gate, the second visible symbol being obscured in the open position of the valve gate, the indicator member and balance stem being operatively connected and configured to moved the indicator member from at least one of the positions toward another of the positions.

10. The gate valve of claim 9 wherein the balance stem and the operating stem have equal cross-sectional areas.

11. The gate valve of claim 9 wherein the indicator member is configured to be moved by the balance stem from the first position to the second position and from the second position to the first position.

12. The gate valve of claim 11 further comprising an extension connected to the balance stem and to the indicator member.

13. The gate valve of claim 9 wherein the balance stem unconnectedly abuts the indicator member so the balance stem drives the indicator member from the first open position to the second closed position and further comprising a spring abutting the indicator member and forcing the indicator member against the balance stem and driving the indicator member from the second closed position to the first open position.

14. The gate valve of claim 9 wherein the symbols are selected from words, colors and arrows.

15. The gate valve of claim 9 wherein the balance stem is rigid with the indicator member.

16. The gate valve of claim 9 further comprising a linkage connecting the balance stem to the indicator member.

17. The gate valve of claim 9 further comprising an extension rod connecting the balance stem to the indicator member.

18. The gate, valve of claim 9 wherein the balance stem and indicator member are coaxial.

19. A horizontal gate valve comprising a housing providing first and second connections for coupling to adjacent conduits and providing a passage between the connections,
a valve gate comprising
a slab of material having an opening therein, the slab being counted in the housing for horizontal movement between a closed position blocking the passage and an open position aligning the opening with the passage,
an operating stem on an end of the slab extending through the housing and having an end exposed to earth's atmospheric air exterior of the valve housing, the operating stem having a cross-sectional area, and
a balance stem on an end of the slab opposite from the operating stem, the balance stem having an end exposed to atmospheric air exterior of the valve housing, the balance stem having a cross-sectional area in the range of 95-105% of the operating stem cross-sectional area, and
an indicator comprising a housing, rigid with the valve housing, providing a channel having an opening therein, an indicator member in the channel having a symbol indicating an open/closed condition of the valve, the indicator member being movable from a first position in the channel exposing the symbol through the opening and thereby indicating the position of the valve gate and a second position in the channel obscuring the symbol indicating the position of the valve gate, the indicator member and balance stem being operatively connected and configured to move the indicator member between the first and second positions in response to movement of the valve gate between open and closed positions.

20. The horizontal gate valve of claim 19 wherein the housing includes side walls providing a channel therebetween, a top having an opening therein and a bottom having an opening therein, the indicator member having a first symbol on a first side of the indicator member indicating an open position of the valve and a second symbol on the first side of the indicator member Indicating a closed position of the valve, the indicator member being mounted for pivotal movement between a first position exposing the first symbol through the top opening and obscuring the second symbol inside the channel and a second position exposing the second symbol through the bottom opening and obscuring the first symbol inside the channel.
